(19) United States
(12) Patent Application Publication
(10) Pub. No.: US 2007/0121784 A1
(43) Pub. Date: May 31, 2007

(54) X-ray imaging arrangement

(75) Inventors: Bjorn Cederstrom, Enskede (SE); Mats Danielsson, Taby (SE); Erik Fredenberg, Stockholm (SE)

Correspondence Address: NIXON & VANDERHYE, PC, 901 NORTH GLEBE ROAD, 11TH FLOOR, ARLINGTON, VA, 22203, US

(73) Assignee: Sectra Mamea AB, Kista (SE)

(21) Appl. No.: 11/522,536

(22) Filed: Sep. 18, 2006

Related U.S. Application Data
(60) Provisional application No. 60/718,315, filed on Sep. 20, 2005.

(51) Int. Cl. G01N 23/04

(52) U.S. Cl. 378/62

(57) ABSTRACT

An x-ray system for narrow bandwidth imaging of in particular small objects is provided. X-radiation from an x-ray source (1) is focused by chromatic x-ray optics (2) on an x-ray energy dependent distance from the optics. Asymmetric focusing of the x-ray optics is compensated for by choosing an asymmetric focal spot of the source. The energy selective focusing makes possible blocking unwanted x-ray energies (3) from reaching an object (4). In that way optimization of the energy according to the size of the object can be done to minimize dose and maximize signal-to-noise ratio (7). Furthermore, a critical edge subtraction image can be obtained at the object dependent optimal energy if the object is injected with a contrast agent having an absorption edge close to the optimal energy (8). Radiation is registered (5) and processed (6) to combine structural and energy subtraction images.

### TECHNICAL FIELD OF THE INVENTION

The present invention generally relates to imaging, especially X-ray imaging and arrangements and methods associated therewith. The invention also concerns medical decision support and improvements of existing diagnostic imaging methods, particularly for small objects.

### BACKGROUND OF THE INVENTION

The important role of medical imaging for diagnosing various kinds of disease is unquestionable. Especially for many forms of cancer, the second most common cause of death in the western world today, early detection is vital for the chances of survival. Also for cardiovascular disease, the most common cause of death in the western world, imaging of particularly the vascular system plays an important role for diagnosis.

In recent years, there has been a growing interest in the use of clinical imaging methods also within biomedical research for imaging animal models of disease and function. Traditional studies of animal models usually have required sacrificing the animal for each event to be investigated. In time resolved studies this means that, in order to compensate for statistical fluctuations, not only one but several animals have to be sacrificed at each stage of the experiment. Using non-invasive small animal imaging, however, there is no need to compensate for fluctuations since the examination can be conducted in vivo; the same animal is used at every stage of the experiment and can serve as its own control. Ergo, the total number of animals used can be extensively reduced. Except for obvious ethical reasons of this concept, there are also strong economical and time saving advantages.

However, rodents commonly used for research, such as mice, are roughly about ten times smaller than humans, which means that the volume of their organs is about a thousand times smaller than human counterparts. This also means that the volume of a resolution element in an imaging system has to be correspondingly smaller, which has led to the development of dedicated small animal imaging arrangements. For imaging modalities employing ionizing radiation, as the resolution increases, so does the radiation dose to the subject. If the signal from a resolution element needs to be kept unchanged compared to a clinical system (which is reasonable), the dose roughly scales with the volume of a voxel, which leads to a considerable increase. Clearly, the dose to the subject is allowed to be higher when imaging animals than is accepted in a clinical set, yet the radiation effect on the animal has to be negligible. It is therefore not surprising to note that there is a constant need for improvement of existing imaging methods as to sensitivity.

Due to relatively low costs and easy maintenance as well as early introduction, x-ray imaging is the most widespread modality today. The introduction of computed tomography (CT) made possible imaging of a plane in the object with no influence of over and under lying tissue, as well as 3D-reconstruction. Two major disadvantages of all kinds of x-ray imaging are, however,
a) the radiation dose put upon the subject (compared to for instance MRI), which increases with spatial resolution and signal to noise ratio, and
b) the lack of information about function and tissue character (compared to PET, SPECT and f-MRI).

Grodzins [Optimum energies for x-ray transmission tomography of small samples. Nucl. Instr. Meth., 206:541-545, 1983] suggested that in order to maximize the SNR at a certain dose, thus addressing the problem (a) above, the exposure is preferentially done at a specific, on the object size depending, x-ray energy. X-ray imaging therefore benefits from narrow bandwidth radiation.

A method to further increase the contrast of a certain organ or part of the body and thus decreasing the dose to the subject well known in the prior art, is to introduce a high atomic number contrast agent. In particular, iodine is used for imaging the vascular system since it can be easily bound to sugars, which are readily accepted by the body. The drawback is that the x-ray attenuation of iodine is fairly weak, and large amounts of the substance have to be injected into the animal or human, being imaged. This is a problem since iodinated contrast agents are not harmless.

There are several heavy elements with better absorption properties than iodine, which might be more suitable for many imaging applications. Often however, heavy elements are foreign to the body and will be disposed of quickly, and most are toxic even in small amounts. Metals for instance, due to the huge surface area to volume ratio if small particles are used, and the slightly hostile environment of the blood, might upon intravenous injection form ions which interfere with the body systems in various ways.

Hainfeld et al. suggest a solution to this problem in U.S. Pat. No. 6,818,199. By covering inert metal nanoparticles, in particular colloidal gold with a layer of carbohydrates, the particles can be injected, in particular intravenously, in relatively large amounts into a living animal without toxic effects. Since gold and many other heavy metals exhibit higher x-ray absorption than iodine, contrast can be significantly improved by employing such a contrast agent compared to conventional ones. The authors also suggest covering a nanoparticle of a toxic metal, such as lead, with a more inert one, such as gold, thus keeping the attractive surface properties and low toxicity of gold, and at the same time reducing costs and maintaining high absorption.

A way to address the problem (b) of x-ray imaging is to direct mentioned contrast agent to a specific location in the body according to its character or function. That is, basically, the principle employed by the major functional imaging modalities used today, PET, SPECT, and f-MRI. The above mentioned low sensitivity of x-ray imaging to iodinated contrast agents previously has made such attempts practically impossible because the high concentration needed for detection would be very hard to direct to a specific location in the subject and once there, the agent would in many cases perturb the very function it is supposed to measure. Hainfeld et al., in the already mentioned patent, recognize this problem of conventional contrast agents and suggest using the, in the patent described, novel contrast agent coupled to a target specific molecule such as an antibody or the like. This is a promising approach, however antibodies are large macromolecules (usually in the kDa range), and the concentration of epitopes in target tissue may be low, which means that the number of label molecules on each antibody, despite the anticipated increase in contrast of three times, needs to be very large. The label complex might thus be very bulky and show limited extravasation from the vasculature system, as well as slow diffusion through the interstitial space. In deed, limited kinetics of the target specific molecule is identified as one of the major obstacles of target specific f-MRI [D. Artemov. Molecular magnetic resonance imaging with targeted contrast agents. J. Cell. Biochem., 90:518-524, 2003], and will most likely be so also for the contrast agents proposed by Hainfeld et al. This is a fair comparison since contrast agents for f-MRI also in many cases are bulky metal complexes. Therefore, even higher sensitivity is desirable.

Nevertheless, the sensitivity of an x-ray imaging system to a contrast agent can be improved by several methods. A very promising such method, here referred to as critical edge subtraction, relies on the fact that at a material specific energy the absorption coefficient of the contrast agent material changes rapidly. A so called absorption edge is caused by the radically increased cross section of photo electric interaction between an incident photon and an atom in the material as the energy of the photon reaches the binding energy of a lower atomic shell, which can then also take part. To perform critical edge subtraction, monochromatic or quasi-monochromatic x-ray absorption images are acquired, simultaneously or consecutively, at several energies, at least one just below and one just above, an absorption edge of the contrast agent. By logarithmically subtracting the two images, the signal contribution of other elements almost cancel due to the very small change in attenuation between the two measurements. The attenuation shift of the agent on the other hand is huge and will be visible in the subtracted image.

The method of critical edge subtraction is well known in the prior art and described in several patents, one of the first ones being U.S. Pat. No. 3,974,386 to Mistretta et al. The major obstacle in performing critical edge subtraction is to obtain acceptably narrow bandwidth tunable x-radiation—already at an energy difference in the order of a few keV the method becomes ineffective—and at the same time maintaining a high enough flux for reasonable exposure times. Therefore, it is widely believed that synchrotron sources are necessary to practice the method. Synchrotrons are, however, rare and expensive establishments, hardly available for routine research, and the requirement of such a source clearly limits the usefulness of the method.

Several patents deal with possibilities to conduct critical edge subtraction using a cheap, easily accessible bench-top arrangement. Shefer et al., in U.S. Pat. No. 4,887,604, propose matching an absorption edge of the contrast agent and the peaks of monochromatic characteristic radiation of an electron impact source. Canistraro et al. in U.S. Pat. No. 5,596,620 further describe means for filtering the characteristic radiation of the source so as to reach a narrower bandwidth using a Bragg reflecting Johansson bent crystal monochrometer. Different types of monochrometers are proposed by Nelson et al. in U.S. Pat. No. 4,969,175, and by Nygren et al. in U.S. Pat. No. 6,091,798. Cederstrom describes in U.S. Pat. No. 6,668,040 a refractive x-ray lens suitable for cheap manufacturing.

A good combination of source and contrast agent, identified by Shefer et al. as well as by Canistraro et al. in the above patents, is the K absorption edge of iodine agents combined with the characteristic radiation of lanthanum or a lanthanum compound. Nevertheless, because potential target materials are restricted by several factors including thermal properties, at a different energy, which might be suitable for a particular imaging situation, such a close match of the target material might not be possible for a given contrast agent. Moreover, in order to minimize motion blur, simultaneous exposures at all required energies are advantageous, which, however, requires energy discrimination by the detector. This is recognized by several patents, for instance U.S. Pat. No. 4,736,398 to Graeff et al. The need for energy discrimination puts restrictions on the choice of detector. As an example, U.S. Pat. No. 4,890,310 to Umetani et al. suggests using the contrast agent material as a component in one part of the detector in order to selectively absorb energy above an absorption edge of the material in that part, whereas radiation of lower energies is let through to a different part of the detector. However, not all materials are suitable to use in a detector.

Therefore, in order not to limit the number of possible source-agent-detector combinations even further, thus maximizing the number of possible exposure energies, flexibility in the choice of contrast agent material is needed.

### SUMMARY OF THE INVENTION

The present invention overcomes these and other drawbacks of the prior art arrangements.

In summary, it is an object to provide an x-ray imaging system having one or more of the following properties:
high resolution,
cheap and easily accessible,
providing narrow bandwidth radiation,
flexible to allow for dose minimization over a large range of object radii, and
possible to combine with high sensitivity distribution imaging of one or several contrast agents.

These and other objects are met by the invention as defined by the accompanying patent claims.

Briefly, the invention proposes an x-ray imaging system that comprises an x-ray source, chromatic x-ray optics for focusing radiation from the x-ray source on a distance according to the wavelength or x-ray energy of the radiation, means for blocking unwanted x-ray energies from the x-ray source having been focused by the x-ray optics, a detector for registering radiation from the source that has been focused by the x-ray optics and has passed an object to be imaged. The imaging system also comprises image processing means for converting the data registered by the detector into a for diagnostic purposes useful image, and the x-ray source has a shape that is adapted to the x-ray optics.

In a preferred exemplary embodiment of the invention, the x-ray source has an asymmetric shape adapted to compensate for asymmetric focusing effects of said x-ray optics and so as to establish a symmetric point spread function from the object onto the detector.

Preferably, the x-ray optics comprises an arrangement of one or more chromatic x-ray lenses. In a particularly preferred embodiment, each lens is adapted for focusing radiation in only one direction, and the blocking means is for example formed by one or more slits, where each lens is associated with a respective slit. The arrangement of chromatic x-ray lenses filters the radiation so as to obtain only a narrow bandwidth of the radiation from the source, preferably the characteristic radiation.

By choosing an appropriate asymmetric focal spot of the x-ray source it is possible to compensate for asymmetric focusing effects of the x-ray optics. If the optics comprises the mentioned arrangement of one-directional focusing x-ray lenses, the x-ray source focal spot is preferentially a line focus.

The system is intended to image an object, which is optionally injected with a contrast agent for target or tissue specific labeling, the contrast agent preferably containing a bulk material with an absorption edge situated between at least two peaks of characteristic radiation from the source. This allows for sensitively detecting the contrast agent inside the object using critical edge subtraction.

Optimization in terms of signal-to-noise ratio and dose to the object can optionally be obtained by selecting a combination of target material for the x-ray tube and contrast agent material, at a suitable energy according to the size of the object. Due to the flexibility of this system, such a combination can be found at many energies and a critical edge subtraction image can be obtained along with a structural image at optimum energy. This keeps the dose at a minimum at the same time as high sensitivity labeling allows for imaging of function and tissue character, as well as improvement of the contrast of body structures.

The detector can be energy discriminating to allow for images at all necessary energies to be acquired simultaneously. If the x-ray optics comprise the mentioned one-directional focusing lenses, it can be advantageous to use an electronic row detector to increase effectiveness and to reject scattered radiation.

It is found that the advantages of the system become most apparent when imaging small objects such as small animals used for research.

Equipment and materials necessary to realize this system are all easily accessible at a relatively low cost, and therefore it is particularly suitable for routine research.

The invention distinguishes itself from the prior art by combining different technologies into a novel, advantageous, and very flexible arrangement.

In another aspect of the invention, there is provided a method for performing combined structural and functional x-ray imaging of an object. The method preferably comprises finding the energy at which the dose minimum for a particular object size occurs, and a combination of suitable target material for an electron impact source with a contrast agent material so that the characteristic radiation peaks of the target material fall on both sides of an absorption edge of the contrast agent material, which is located at or near the energy at which mentioned dose minimum occurs. As the target material is exposed to a high energy electron beam it emits radiation, which is focused by chromatic x-ray optics so that radiation at unwanted x-ray energies can be blocked. To compensate for the fact that some x-ray optics are asymmetric, the area of exposure of the electron impact source is adapted to the optics being used. Remaining radiation can be let to pass an object which is injected with contrast media, and the radiation is detected. The detected data is preferably processed in a computer so as to obtain an energy subtraction image, which is combined with a regular absorption image.

Other advantages offered by the invention will be appreciated when reading the below description of embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematic block diagram of an exemplary preferred embodiment of the invention;

FIG. 2a is a schematic diagram of an exemplary embodiment of the invention, implemented with a chromatic x-ray lens and an area detector;

FIG. 2b is a schematic diagram of an exemplary embodiment of the invention, implemented with a chromatic x-ray lens and a row detector; and

FIG. 3 is a schematic block diagram of an exemplary preferred method to make use of the advantages provided by the invention.

### DETAILED DESCRIPTION OF EMBODIMENTS OF THE INVENTION

Monochromatic x-ray imaging in general and computed tomography in particular has mainly two advantages compared to conventional polychromatic x-ray imaging [F.A. Dilmanian. Computed tomography with monochromatic x-rays. Am. J. Physiol. Imaging, 3:175-193, 1992]; the first of which is improving the image quality and by that the resolution, and the second one is enhancing the contrast per photon and accordingly minimizing the dose to the object.

Firstly, a polychromatic beam will be filtered by the object, and since the probability of x-ray absorption decreases with energy, the mean energy of the beam will be shifted towards higher energies by passing the object. This effect is called beam hardening and will cause image artifacts in tomographic imaging because the reconstruction algorithm assumes the signal to be independent of the ray path. Beam hardening can be compensated for by different methods, however only to a certain extent, and the only way to get rid of the effect altogether, is to use monochromatic radiation.

The second advantage of monochromatic x-ray imaging is the possibility to optimize the energy with respect to contrast, and by doing so minimizing the dose to the object. An approximate optimization for the case of tomographic x-ray imaging can be done by finding the energy at which the linear attenuation coefficient of the object satisfies the condition [L. Grodzins. Optimum energies for x-ray transmission tomography of small samples. Nucl. Instr. Meth., 206:541-545, 1983]

$$μ = \frac{2}{D} , \qquad ( 1 )$$

where D is the thickness of the object.

Both of the above assets of monochromatic x-ray imaging become more evident at low mean energies and hence, due to an essentially monotonically decreasing μ with energy and equation (1), at small object diameters. This is due to the steeper slope of the attenuation coefficient curve at low x-ray energies, and makes monochromatic radiation especially beneficial for imaging small objects. Typical sizes of small object considered here, such as animals commonly used for research, are in the range 0.5-10 cm, and if tissue is approximated by water this corresponds to an x-ray energy range of roughly 10-40 keV according to eq. (1). As mentioned in the background to this invention, there exists a great need in biomedical research to non-invasively image animal models of disease and function, such as rodents, in order to reduce the number of animals having to be used.

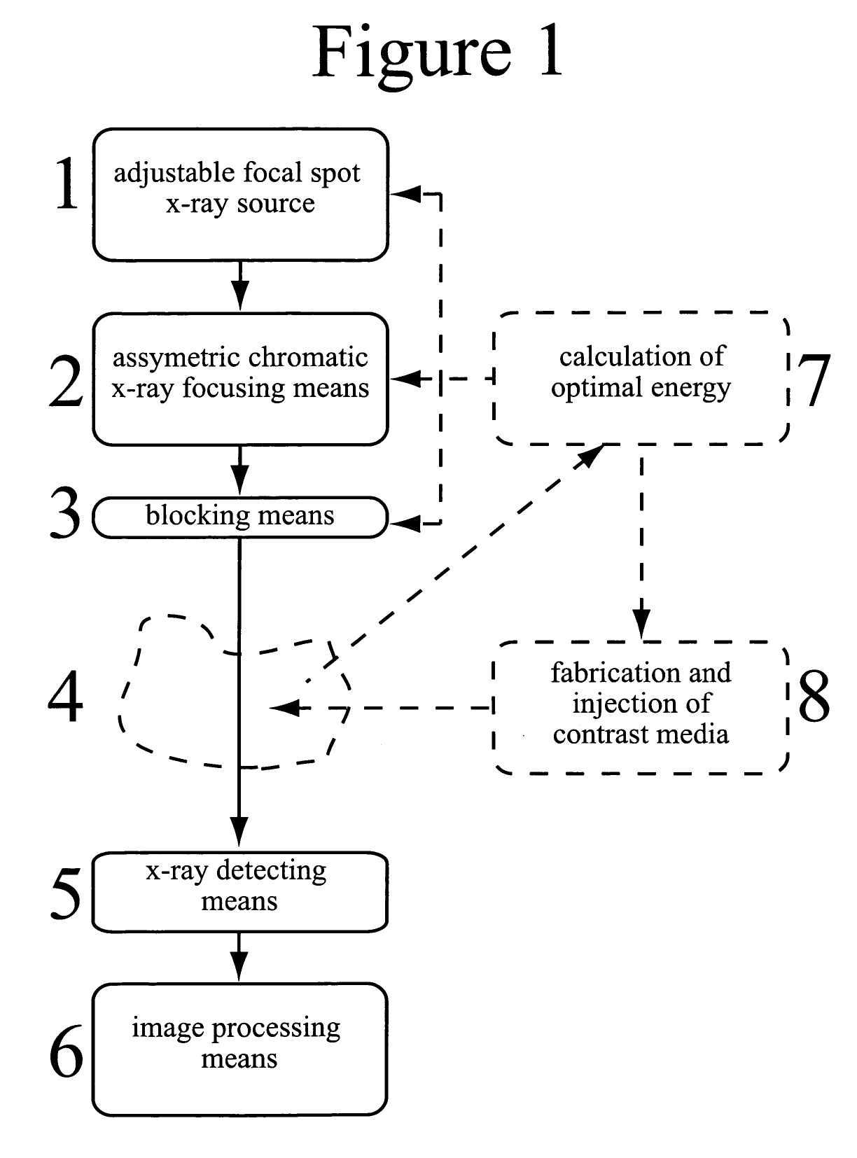

An exemplary general arrangement according to FIG. 1 is proposed. An x-ray source (1) provides x-radiation which is focused by chromatic x-ray optics (2) on a distance from the optics according to the x-ray energy (dependent on the wavelength) of the radiation. By this selective focusing it is possible to block unwanted x-ray energies (3) from reaching an object (4) placed in the arrangement. In that way it is possible to (optionally) optimize the energy of the illuminating radiation to the size of the object so as to minimize the dose and maximize the signal-to-noise ratio (7). A detector (5) registers radiation that has passed the object, and image processing means (6), e.g. implemented in a computer, finally converts the data from the detector into a useful image for diagnostic purposes. The x-ray optics might provide asymmetric focusing, and therefore the shape of the x-ray source is either pre-adjusted or adjustable to compensate for this asymmetry so that a symmetric point spread function is obtained on the detector. As will be seen below, it is also possible to (optionally) detect contrast agents injected into the object at a very high sensitivity (8).

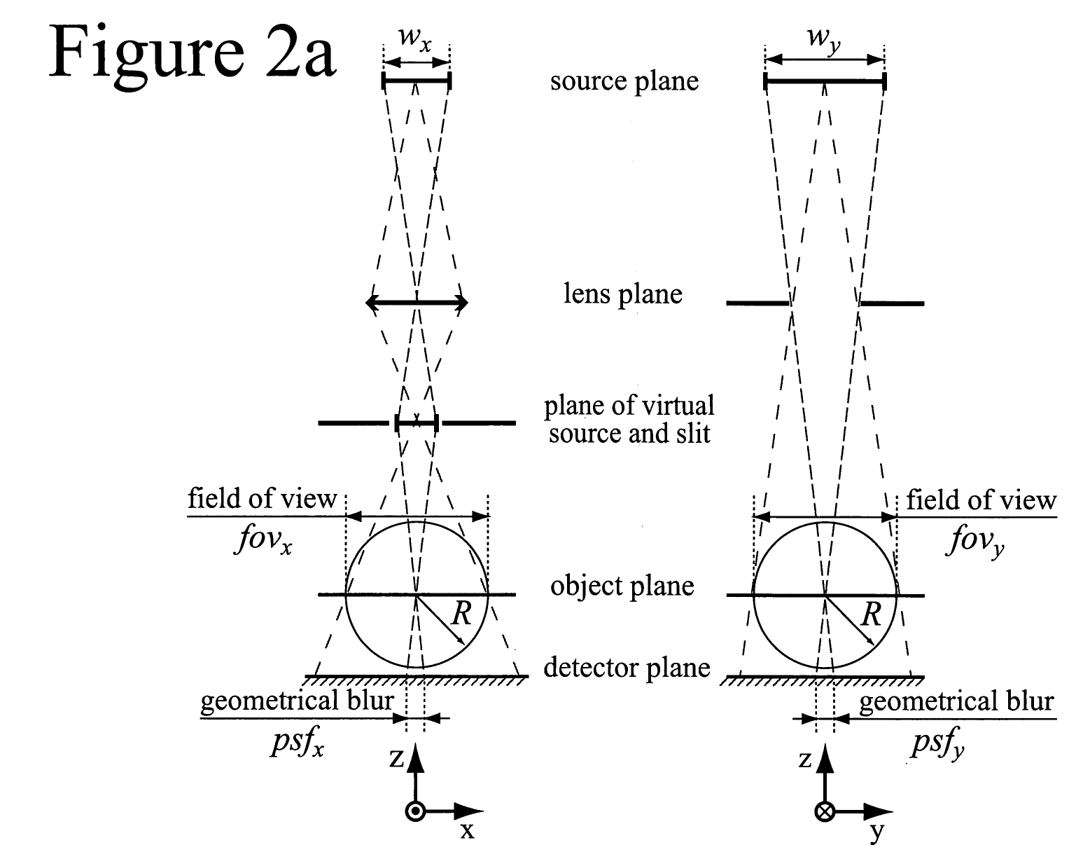

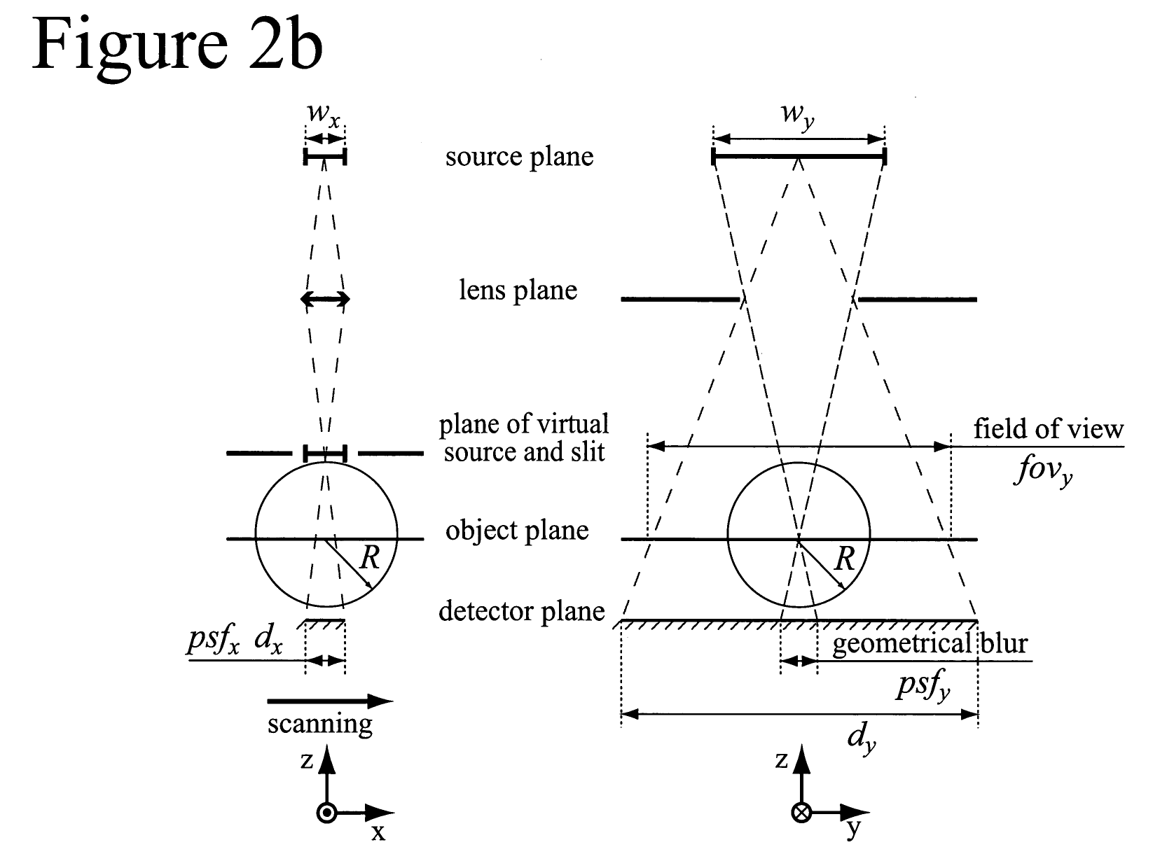

An exemplary preferred embodiment of the invention is shown in FIG. 2a. Preferably, a lens, either a multi prism refractive x-ray lens, described by Cederstrom in U.S. Pat. No. 6,668,040, or a prism array lens, also described by Cederstrom [B. Cederstrom, C. Ribbing, M. Lundqvist. Generalized prism array lenses for hard x-rays. J. Synchrotron Rad., 12:340-344, 2005], is used. Cederstrom recognizes the possibility for imaging applications, however only for a few particular situations and not for the advantageous setup and combination described here. A similar lens system as Cederstrom's is described by Nygren et al. in U.S. Pat. No. 6,091,798, but has the drawback of being harder to manufacture.

The multi prism lens, which is also referred to as a “saw tooth” lens, comprises two arrays of prisms put on an angle in relation to each other, touching at the entrance side of the lens and separated at the exit side. Peripheral rays entering the lens encounter a larger number of prisms on their way through the lens than do central ones, and therefore experience a greater refraction. Since the refractive index of any lens material varies with x-ray energy, the lens is strongly chromatic. It focuses incoming x-radiation in only one direction—into line foci—on energy dependant distances from the lens. The focal length of the lens can be changed by simply varying the angle between the lens halves. A more detailed description of the lens can be found in the above mentioned patent.

A prism array lens comprises a number of small prisms arranged in columns perpendicular to the optical axis. The columns are displaced in the vertical direction from the optical axis, and the displacement increases in the direction parallel to the optical axis. This means that the projection of lens material is linear with a Fresnel pattern superimposed on it. Again, peripheral rays encounter more prisms than central rays, and are accordingly more refracted. The prism array lens is likewise strongly chromatic and focuses radiation into line foci, but it is more efficient than the multi prism lens since unnecessary lens material corresponding to a phase shift of 2π is removed. It is, however, harder to manufacture and the focal length is fixed. A more detailed description of the lens can be found in the above mentioned article.

Referring again to FIG. 2a, the lens has its refractive effect in the xz-plane and forms a diminished image of the source—a virtual source—on a slit. The slit is on a distance from the source so that only radiation of the desired energy is in focus, and the slit thus cuts away most of the unwanted x-ray energies, which are out of focus and spread out over a larger area. The radiation that remains to illuminate the object is therefore essentially monochromatic. To tune the transmitted x-ray energy, either the focal length, or the distance from the lens to the slit can be adjusted. In the yz-plane the setup works as a regular shadow imaging arrangement without influence of the lens.

Due to the one-directional focusing of the lens, the magnification in the xz- and yz-planes differ, and therefore the resolution will also be dissimilar in the two planes. Such asymmetric resolution is undesirable since it means that in one of the directions the resolution has to be better than necessary at a certain limiting resolution, and photon economy is compromised. Again referring to FIG. 2a, the solution to this problem will be to use an asymmetric source focus with sizes wₓ and w_{y} in x- and y-directions adjusted to achieve a symmetric point spread function or geometrical blur at the detector (psfₓ=psf_{y}). To match the line foci of the described x-ray lenses, the asymmetric source preferably comprises a line focus x-ray tube. Such x-ray tubes are commercially available today. The shape of the focal spot can be adapted by changing the area of electron impact or, which is simpler but less efficient, by collimation or change of viewing angle of the source.

The choice of detector to detect radiation having passed the object is based on the particular setup and imaging situation, but is preferentially an electronic one to allow for digital image processing. Again due to the one-directional focusing, the system benefits from being coupled to one-dimensional row detectors such that the width of the beam in the x-z-plane matches the width of a detector (dₓ), which is one pixel. This is illustrated in FIG. 2b. The image of the source, the virtual source, is preferentially located close to the object so that the width of the beam through the object, which determines the point spread function (psfₓ), is kept narrow and matches the point spread function in the y-z-plane (psf_{y}). The length of the detector (d_{y}) matches the field of view in the y-z-plane (fov_{y}) and the system scans the object in the x-direction in order to obtain area information. To increase the effectiveness it can be built up by several lenses, each coupled to a detector and focusing radiation thereto. Such a system is very efficient for scatter rejection since most scattered photons pass between the detectors, still the system has good photon economy. Row detectors, for instance silicon strip detectors, can be made energy sensitive. Nevertheless, for small object sizes and high resolutions it might be disadvantageous to restrict the width of the beam to only one pixel, and in that case an area detector, such as a CCD, might be used in conjunction with the system. This is illustrated in FIG. 2a. The image of the source is preferentially located a distance away from the object in order to decrease the geometrical blur. In both lateral directions the detector covers the field of views (fovₓ, fov_{y}) and no scanning is necessary. Additionally, at the low x-ray energies which are optimal for small object sizes, scatter might be negligible. Area detectors are, however, in most cases restricted when it comes to energy sensitivity.

By theoretical calculations it has been found that within reasonable resolution limits (1-100 μm) for imaging small objects such as small animals (0.5-10 cm), the ratio of irradiance in the detector plane between the here described setup using a prism array lens and a regular shadow imaging arrangement varies between 0.05 and 0.2. This is, of course, a significant reduction, but compared to alternative systems for narrow bandwidth radiation very reasonable, and by using the high intensity characteristic radiation peaks of modem high brilliance micro focus sources should impose no great problem as to exposure time. Additionally, due to the fact that there is a limit to how short the focal length of the lens can be made, the setup is more effective at higher resolutions and is therefore particularly suitable for imaging small objects.

Since the present invention can be realized with easily manufacturable, easily accessible, and easily maintained equipment and materials, it can be produced at a relatively low cost and is suitable for routine research. Furthermore, the relatively small and light construction of the present invention enables the source detector pair to rotate around the subject, thus making possible image acquisitions from several angles and tomographic reconstruction in accordance with common algorithms for x-ray computed tomography. This is put in contrast to the case of for instance using a synchrotron radiation x-ray source, which is expensive, scarcely available, and in many ways hard to operate.

Another asset of the present invention compared to prior art is the possibility to combine an image obtained at an optimal energy, in terms of signal-to-noise ratio and dose according to eq. (1), with a critical edge subtraction image of a contrast agent distribution, contributing additional information about structure and function. In the present invention, these images can be acquired simultaneously, which reduces the dose to the subject compared to the case when two different exposures are needed.

Critical edge subtraction was identified by Ritman [Micro-computed tomography—current status and developments. Annu. Rev. Biomed. Eng., 6:185-208, 2004] as being the most sensitive method for detecting small amounts of a contrast agent in small animal imaging. Monochromatic x-ray absorption images are acquired, simultaneously or consecutively, at several energies, at least one just below and one just above, an absorption edge of the substance being used as contrast agent. By logarithmically subtracting the two images, the signal contribution of other elements almost cancel due to the very small change in attenuation between the two measurements. The attenuation shift of the agent on the other hand is huge and will be visible in the subtracted image. This method is described by several patents, as stated in the background to this invention. Usually the K absorption edge of the contrast agent will be used for imaging since the attenuation shift of a particular element is greatest at that energy, although of course imaging at for instance the L3-edge is also possible. Materials having a K-edge in the above mentioned energy interval for small objects, such as small animals, have atomic numbers roughly in the range 30-60.

To obtain dual energy radiation in a bench-top setup at a high enough flux for keeping the exposure time within reasonable limits, it might be necessary to take advantage of the high flux peaks of characteristic radiation of an electron impact source, either by choosing a source-agent combination so that an absorption edge of the agent falls between two different characteristic emission lines of one single anode material of the source, or by employing characteristic radiation from two different anode materials. The present invention further provides means to block unwanted bremsstrahlung or characteristic radiation in a setup that differs from the one proposed by Canistrato et al. in U.S. Pat. No. 5,596,620, which preferably comprises the above described arrangement of chromatic lenses. Since the two emission peaks of the source have a very small energy difference, the virtual sources projected by the x-ray lens will in most cases be imaged in essentially the same plane, making readjustments unnecessary and simultaneous exposure possible. If this is not the case, several lenses can be placed in an array being individually preadjusted according to energy, so that in a scanned system, without any mechanical readjustments, the total effect of a scan will be the same. If no suitable target material for characteristic radiation can be found, the described setup also allows for critical edge subtraction by filtering a continuous bremsstrahlung spectrum, however at a lower sensitivity.

By adding the images obtained at all energies, it is also possible to acquire a regular structural image along with the subtraction image. All image processing is preferentially performed in a computer using algorithms that can be easily derived from the above descriptions by the skilled person.

To allow for simultaneous acquiring of images at several energy levels, it can be advantageous if the detector is energy discriminating. In some detectors (e.g. U.S. Pat. No. 4,890,310 to Umetani et al.) radiation of different x-ray energies are registered in different planes, which means that the magnification of the images formed by these energies also will be different. This effect can be compensated for by choosing appropriate focal lengths of the lenses so that the images formed by the lens at all energies will have the same distance to their respective detectors.

At ideal conditions, a setup as the one described here for critical edge subtraction provides contrast of a contrast agent several orders of magnitude higher than regular absorption imaging. This is, however, not recognized by Nygren et al. or by Cederstrom in above patents and article.

In order to account for variations in object size so as to choose an energy optimal for the subject being imaged, great flexibility is required in the choice of contrast agent material. This is to be able to match a contrast agent absorption edge to the characteristic radiation of the source and to the detector. As already discussed, such flexible contrast agents exist in the art, and are described by Hainfeld et al. in U.S. Pat. No. 6,818,199. Hainfeld et al. propose covering a nanoparticle with a thin film of a biocompatible element, such as gold. The core material still makes up the bulk of the particle, and the x-ray. absorption properties of the particle as a whole will be mainly those of the core metal. Yet, the attractive surface properties and biocompatibility of the shell material is kept intact. This type of contrast agent makes possible the use of virtually any contrast material since the shell layer can be made very thin, still very stable. The concentration of contrast agent material can be made very high due to the very thin shell and the core of solid material, not diluted in any way and having a total number of atoms rapidly increasing with radius. The particle can be directed to a particular tissue or site in the body by means of size, surface chemistry, target specific macromolecules, and others further described in the patent to Hainfeld et al.

Hainfeld et al. hint at the possibility of using the novel contrast agent in conjunction with a method called K-edge imaging, which resembles what is here referred to as critical edge subtraction. However, the flexibility of the contrast agents is not recognized as an advantage for the method in the same sense as here described. Additionally, Hainfeld et al. assume synchrotrons to be used as x-ray source, which is a severe limitation due to high costs, low availability, and other already mentioned reasons.

Yet another advantage of the superior flexibility provided by the present invention is the ability to distinguish the distribution of several different types of contrast agents present in the object at the same time and having different distributions. This is possible if the different types of agents contain materials with absorption edges at different energies and the critical edge subtraction method described above is performed at all these energies. Thus the simultaneous labeling of several structures or functions is possible and additional information can be obtained. If the absorption edges of the different contrast agents are all in a small energy interval, it is still to a certain extent possible to take advantage of the assets of narrow bandwidth radiation for dose and signal-to-noise ratio.

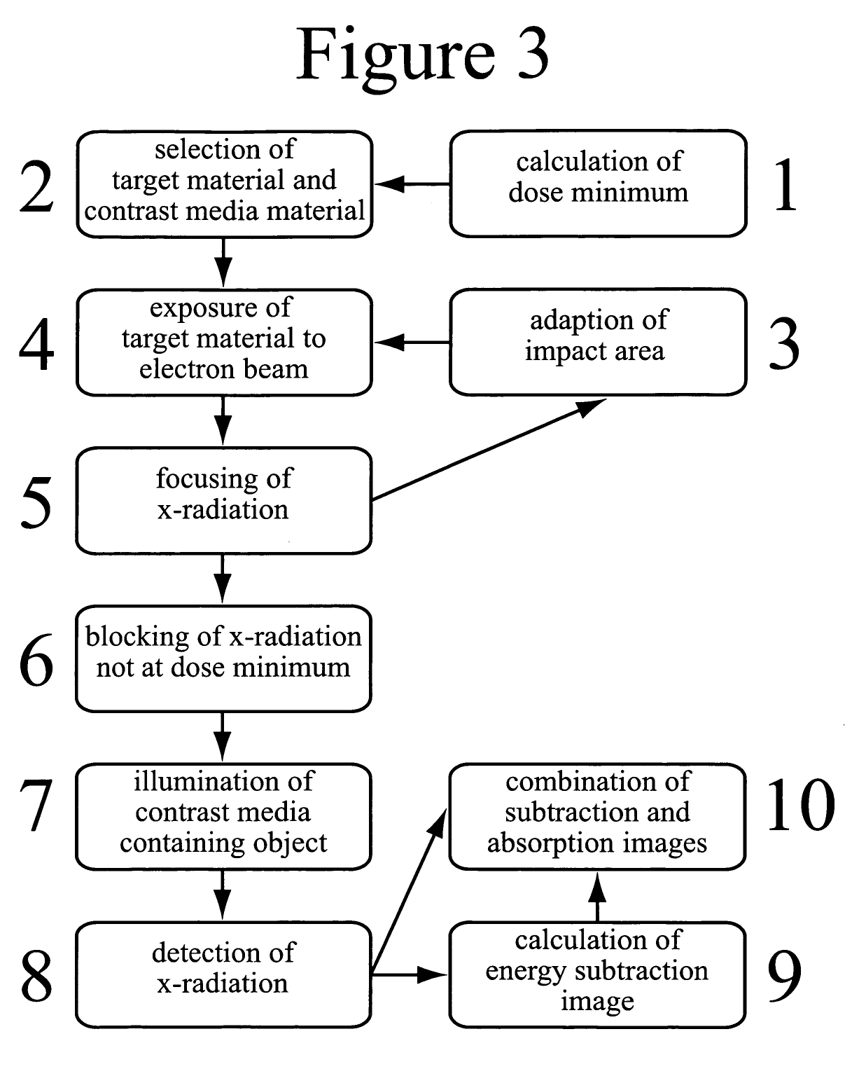

With the described embodiment of the present invention it is possible to perform combined structural and functional x-ray imaging of an object with a method depicted in FIG. 3. The steps of this method are all described in the above, but are summarized here for completeness. The energy at which the dose minimum for a particular object size occurs is calculated (1) and one or several suitable target materials for an electron impact source are found and combined with one or several contrast agent materials (2) so that the characteristic radiation peaks of the target material match absorption edges of the contrast agent material, as described above, for performing critical edge subtraction at or near the energy at which mentioned dose minimum occurs. The target material is exposed to a high energy electron beam and emits brehmsstrahlung and characteristic radiation at a wide energy interval (4), which is focused by the chromatic x-ray optics (5) so that radiation at unwanted x-ray energies can be blocked (6), for instance by means of a slit. Some x-ray optics are asymmetric, and to compensate for this the area of exposure of the electron impact source is adapted to the optics being used (3). Remaining radiation can be let to pass an object which is injected with contrast media (7), and the radiation is detected (8). The data from the detector is preferably processed by a computer so as to obtain an energy subtraction image (9), which is combined with a regular absorption image (10).

The embodiments described above are merely given as examples, and it should be understood that the present invention is not limited thereto. Further modifications, changes and improvements which retain the basic underlying principles disclosed and claimed herein are within the scope of the invention.

1. An x-ray imaging system for selective energy imaging of an object, said system comprising:
an x-ray source;
chromatic x-ray optics for focusing radiation from said x-ray source on a distance according to the x-ray energy of said radiation;
blocking means for blocking unwanted x-ray energies from said x-ray source having been focused by said x-ray optics;
detecting means for registering radiation from said source that has been focused by said x-ray optics and has passed said object to be imaged;
image processing means for converting the data registered by said detecting means into a for diagnostic purposes useful image;
said x-ray source having a shape that is adapted to said x-ray optics.

2. An x-ray imaging system according to claim 1, wherein said x-ray optics comprise at least one refractive x-ray lens.

3. An x-ray imaging system according to claim 2, wherein said at least one x-ray lens comprises at least one multi prism refractive x-ray lens.

4. An x-ray imaging system according to claim 2, wherein said at least one x-ray lens comprises at least one prism array lens.

5. An x-ray imaging system according to claim 1, wherein said system is adapted for imaging an object having a size in the range 0.5-10 cm.

6. An x-ray imaging system according to claim 1, wherein said system is adapted for imaging an object being a living animal.

7. An x-ray imaging system according to claim 6, wherein said living animal is a small animal commonly used for research, such as a mouse or a rat.

8. An x-ray imaging system according to claim 1, wherein the energy illuminating said object is optimized to the size of said object so as to approximately minimize the radiation dose to said object at a certain signal-to-noise ratio;
said energy optimization or adjustment at least partially being achieved by adjusting said x-ray optics and said blocking means so as to selectively block other energies.

9. An x-ray imaging system according to claim 8, wherein contrast media, optionally being contained within an object being imaged, has contrast agent particles all made of the same bulk material.

10. An x-ray imaging system according to claim 8, wherein contrast media, optionally being contained within an object being imaged, comprises two or more different types of contrast agents particles, each type made of a different bulk material and each type intended to have a different distribution in said object.

11. An x-ray imaging system according to claim 9, wherein each of said bulk materials has an absorption edge at, or in the close vicinity of, said optimal energy, and the radiation illuminating said object can be further adjusted so as to illuminate said object at a distribution of energies on both sides, and in the vicinity, of each of said absorption edges.

12. An x-ray imaging system according to claim 8, wherein said x-ray source is an electron impact source, and said energy optimization or adjustment is further enhanced by choosing one or several target materials of said source, the material(s) having characteristic radiation peaks at said energies.

13. An x-ray imaging system according to claim 11, wherein said bulk material(s) of said contrast agent(s) have atomic numbers in the range 30-60.

14. An x-ray imaging system according to claim 11, wherein said contrast agent(s) are covered with a thin film of a biocompatible material.

15. An x-ray imaging system according to claim 14, wherein said contrast media is further covered with organic molecules.

16. An x-ray imaging system according to claim 1, wherein said chromatic x-ray optics comprise at least one lens, each lens focusing radiation in only one direction, and said blocking means comprise at least one slit, each lens being associated with a respective slit.

17. An x-ray imaging system according to claim 16, wherein said detecting means comprise at least one row detector; each row detector being associated with a lens; each lens focusing radiation onto the respective row detector.

18. An x-ray imaging system according to claim 1, wherein said image processing means allow for logarithmic subtraction of images obtained at different energies so as to create a final energy subtraction image, said energy subtraction image being superimposed onto a regular absorption image.

19. An x-ray imaging system according to claim 1, wherein said x-ray source and said detecting means are rotating relative to the object to enable reconstruction of a three dimensional image.

20. An x-ray imaging system according to claim 1, wherein said x-ray source is adapted to have an asymmetric shape to compensate for asymmetric focusing effects of said x-ray optics and so as to establish a symmetric point spread function from said object onto said detecting means.

21. A method for performing combined structural and functional x-ray imaging of an object, said method comprising the steps of:
finding the dose minimum in terms of the energy for the object being imaged;
selecting one or several materials suitable as electron targets based on one or several elemental media to be used as contrast agents,
each of said media to be used as contrast agents having an absorption edge at, or in the close vicinity of, the energy at which said dose minimum has been found;
said materials suitable as electron targets emitting characteristic radiation upon electron impact at a distribution of energies on both sides, and in the vicinity, of each of said absorption edges;
exposing said materials suitable as electron targets to a high energy electron beam at a small area of the material, so that the material emits x-radiation;
focusing said x-radiation with chromatic x-ray optics;
blocking x-radiation at energies not in the close vicinity of the energy at which said dose minimum has been found;
letting x-radiation having not been blocked pass an object placed in the ray path;
said object containing contrast agents formed by said media;
said agents having distributions in the object that correspond to function or tissue character;
detecting x-radiation that has passed the object by means of an x-ray detector;
adapting the shape of said area of said target material exposed to said high energy electron beam so as to obtain a symmetric point spread function at said detector;
logarithmically subtracting images obtained at different energies so as to create (a) final energy subtraction image(s);
superimposing said energy subtraction image(s) onto a regular absorption image.

22. A method according to claim 21, wherein said x-ray optics focus radiation in one direction and said blocking is performed by means of a slit;
said slit being placed in the ray path of said x-ray optics at a distance so that an image of said source is formed onto said slit;
the radiation of said image having energy at, or in the close vicinity of, the energy at which said dose minimum has been found.
